(19) United States
(12) Patent Application Publication
(10) Pub. No.: US 2011/0163121 A1
(43) Pub. Date: Jul. 7, 2011

(54) METHOD AND SYSTEM FOR VOLUMETRIC DISPLACEMENT

(75) Inventor: Victor Katseli, Herzliya (IL)

(73) Assignee: PACK LINE LTD., Holon (IL)

(21) Appl. No.: 13/062,576

(22) PCT Filed: Sep. 7, 2009
(86) PCT No.: PCT/IL09/00868

§ 371 Date: Mar. 7, 2011

(30) Foreign Application Priority Data
Sep. 8, 2008 (IL) 193956

(51) Int. Cl. B67D 7/08

(52) U.S. Cl. 222/1; 222/52

(57) ABSTRACT

Provided is a method for volumetric displacement of a predetermined desired volume ΔV of target material from a first location to a second location. The method including: (a) providing a rigid control volume having a V₀ accommodating a resilient volumetric member coaxially located therein having a target material chamber of volume V1. The target material chamber is confined by an inner surface thereof, and constitutes the first location. The control volume V2 confined between an outer surface of the resilient volumetric member and an inner surface of the rigid control volume. The control volume further includes at least a target material outlet; (b) filling the target material chamber with the target material; (c) introducing a predetermined desired volume ΔV of an incompressible auxiliary material into the auxiliary material chamber to apply pressure to the resilient volumetric member. Thus, there occurs increasing of the volume of the auxiliary material chamber V₂ to V_{2′}=V₂+ΔV and consequently reducing of the volume of the target material chamber from V₁ to V_{1′}=V₁−ΔV; and (d) allowing a predetermined amount ΔV of target material to exit the target material chamber through the target material outlet to the second location.

### FIELD AND BACKGROUND OF THE INVENTION

This present invention relates to a method and an apparatus for the cyclical volumetric portioning of liquids and pasted products based on the predetermined target volume, i.e., for cyclically producing, during each cycle, portions of the dosed product best matching the predetermined target volume. The invention is particularly useful for portioning high viscosity, corrosive and aggressive liquid products used in chemical and food industries, and is therefore described below with respect to such applications.

Packing and/or filling machines must operate at a required speed, and must also include, in each package or a container, at least a minimum volume or weight of a dosed product specified on a package or container, hereinafter referred to as the predetermined target volume. It is virtually impossible, from a practical standpoint, to produce portions with volumes exactly according to a specified targeted volume, and therefore machines generally produce portions with excess volumes over the target volume. Since such excess volume is a “give-away” loss to a producer, it is very important to minimize this excess volume as much as possible.

A few types of dose-volume or volume filling machines are now in common use:

Overflow Liquid Filling Machines.

This type of filler is perhaps the most widely used machine in small bottle filling operations because it handles a wide range of thin, free flowing liquids as well as liquids with medium viscosity. This machine is also commonly referred to as a “fill to level” filling machine or cosmetic height filler. This means that machine fills to a target fill height in the container rather than volumetrically. But it can also be shown that as long as the container specification do not vary greatly, the volumetric accuracy of this machine is excellent.

Because this filler operates in a closed loop basis, it is also ideal for handling foamy products. The Examples of products that work well in this filler are bottled water, liquid soap, motor oil, cleansers and even some dairy products. It can be constructed in both chemical duty versions as well as sanitary versions capable of filling pasteurized products at high temperatures. This machine is relatively low cost and easy to use.

Servo Pump Liquid Filling Machines.

This type of machine is a very versatile filling machine capable of filling nearly any type of product that can be pumped. Each nozzle has a dedicated servo controlled pump that can deliver thin liquids, medium and thick viscosity liquids, and liquids with large particulates. Because it is so versatile, it is often purchased by contract packagers who never know what their next filling challenge is going to be. Examples of the range of products that can be run on this machine include soaps, pharmaceutical products, oils and greases, cosmetics, salsa and sauces, etc. This type of filler is an outstanding choice for nearly any type of filling operation.

Peristaltic Liquid Filling Machines

This filler is the machine of choice for high value, small volume fills at very high accuracy. It is primarily suitable for aqueous and other light viscosity products. Examples of products filled on this machine are sterile and pharmaceutical preparations, fragrances, essential oils, reagents, inks, dyes, and specialty chemicals. The unique advantage of this machine is that the only fluid path is surgical tubing. The fluid path is disposable, easy to cleanup and eliminates cross contamination problems. Accuracies of 0.5% are achievable for fill volumes less than 1 ml.

The peristaltic pumps on this filling machine make intermittent contact on only the outside of the surgical (product) tubing so that the product only touches the inside of the tubing. Like the servo pump filling machine above, this system operates with servo drives. Each servo drive is dedicated to one or two peristaltic pump heads. The filler's master computer independently tracks the # of rotations of the peristaltic pump head so that it knows precisely how much product has been delivered. When the target fill volume is reached, the pump stops and the remaining product fluid does not drip out due to pipette action of the surgical tubing.

Time Gravity Liquid Filling Machines.

This is the most economical type of filling machine for a limited range of applications. This filler is best suited for liquids with very thin viscosities that do not change with ambient temperature or with batch variation. This machine is also suited for applications where recirculation of the liquid in the fluid path is not desirable. This is especially true for corrosive chemical filling like acids and bleach. Other examples of products this machine is well suited to include water, solvents, alcohol, specialty chemicals, paint and inks. Although this type of filler is used predominantly on products that do not foam, foam may be limited and controlled by subsurface/bottom-up fill capability.

The machine works by a simple principle; the amount of liquid flowing through a fluid path will always be the same for a fixed amount of time. It functions as follows: the product bulk supply is pumped into a holding tank above a set of pneumatically operated valves. Each valve is independently timed by the filler's master computer so that precise amounts of liquid will flow by gravity into the container. Independent timing of each filling valve/nozzle corrects for minor variations in flow rates so that each container is filled accurately.

Piston Liquid Filling Machines

The piston filler is one of the oldest and most reliable types of fillers used in the packaging industry. This filling machine is best suited for viscous products that are paste, semi paste, or chunky with large particulates. Piston fillers are primarily built to meet food grade standards and commonly fill heavy sauces, salsas, salad dressings, cosmetic creams, heavy shampoo, gels, and conditioners. They are also used for viscous chemical preparations like paste cleaners and waxes, adhesives and epoxy's, heavy lubricant oils and greases.

The machine works by a simple principle. The piston is drawn back in its cylinder so that the product is sucked into the cylinder. A rotary valve then changes position so that the product is then pushed out of the nozzle instead of back into the hopper. The volume of the product that is sucked into the cylinder is the precise volume that will be dispensed into the container.

The advantage of this type of filling machine is that involves conventional mechanical technology that is easy to understand for most users. It is also the most cost effective, accurate and fastest way to fill fairly thick products. Although more costly than overflow and time gravity systems discussed above, it costs less than the servo pump filler is still the most cost effective filling machine for thick products.

Net Weight Liquid Filling Machines

This type of filler is best suited for liquids filled in bulk quantities e.g. 5 gallon pails, etc. or smaller quantity products that have a very high manufactured value. Oftentimes there are products that must be sold by weight for commercial reasons and therefore this filling machine is the only choice. Examples of this type of filler for bulk products include cleaning chemicals, enzyme solutions, oils and other medium value products. High value products filled by these machines include specialty adhesives and paints, precious metals dissolved in acids, and other expensive specialty chemicals.

The operation of this type of filling machine is simple. The product bulk supply is pumped into a holding tank above a pneumatically operated valve. The valve opens and real time net weight information is monitored until the target weight is achieved. The valve simply shuts when the target weight is achieved. Accuracy of fills is accomplished by various “bulk and dribble” methods in the filling process so that overfills are avoided.

Volumetric Dosing Devices

There are also known in the art devices adapted for filling receptacles with a predetermined volume by volumetric control of the volume exiting the filling machine. Several such examples are disclosed in GB2379719, GB2111605 and GB2292574, all of which are concerned with a control volume provided with a working volume isolated from the control volume, and adapted to be reduced/increased by the introduction of an incompressible auxiliary material into the control volume.

Hazardous Location Liquid Filling Machines

Any of the machines outlined above can be built for Hazardous Location operation. Hazardous location means that there is risk of explosion or auto-ignition of the products being filled. Examples of products like this are alcohol, solvents, petroleum products, paints, etc.

Many of the manual and semi automatic versions of the types of liquid filling machines discussed above are inherently safe since they require no electrical operating systems. However, more sophisticated and higher output automatic machines using electrical systems must be built with intrinsically safe enclosures that are UL listed and conform to the National Electric Code as well as requirements of major insurance carriers. There are automatic liquid filling machines offered in the market with completely pneumatically controlled operating systems.

Corrosive Environment Liquid Filling Machines

As suggested above, time gravity fillers are often used for filling of corrosive products. But sometimes the products being filled are so aggressive that special construction methods are required. Harsh factory environments or where the product being filled can also be particularly aggressive on machinery. This includes not only chemical plants producing strong acids or bleach but also food plants using brine or sugar solutions in their products. In both cases, even the factory air alone contributes to the accelerated degradation of the machinery.

Machine integrity can be enhanced by using special powder and industrial polymer coatings on structural and other exposed machinery components. Also, whenever practical, substitution of chemical resistant plastics such as UHMW and Teflon are used in place of metal.

Not only are the frame components at risk in these environments but the fluid path materials must be specifically chosen for the types of products they come into direct contact with. For example, Kynar and Teflon fluid path materials may be used in a bleach filling machine because of their excellent resistance to the aggressive properties of bleach.

It should be noted that there is no ideal combination of materials in a filling machine when it comes to corrosive filling. Avoidance of some metal components is impossible particularly in the case of fasteners. The operator of this type of machinery should be prepared for stringent maintenance of these types of machines.

Amongst the most meaningful parameters of the dosing and packaging equipment influencing on the end-user's choice are: the accuracy, the operating speed, the control simplicity, the size and the price (the last parameter is a critical one for a majority of the end-users), and maintenance (daily and periodic care and cleaning).

### SUMMARY OF THE INVENTION

The new method according to the present invention for cyclically portioning liquids and pastes by displacing required volume provides the technical base for a variety of “Volumetric Copying Devices” and/or “VCD” which will provide end-users with control simplicity, high accuracy and desired operating speed of packaging and the significantly smaller sizes and lower prices.

The object of the present invention is to provide this new volumetric method for portioning liquids and pasted products at a required rate of operating speed, for example, in the range of 60 portions per minute, and with a minimum excess of the product over the predetermined target volume in order to minimize “give-away” losses, or for otherwise best matching the predetermined target volume, including the cases then the target of a portion can be changed from cycle to cycle in preset limits, and at minimal manufacturing cost of the dosing machine.

According to the present invention, there is provided a method for volumetric displacement of a predetermined desired volume ΔV of target material from a first location to a second location, said method comprising the steps of:
(a) providing a rigid control volume having a volume V₀ accommodating a resilient volumetric member coaxially located therein having a target material chamber of volume V₁ confined by an inner surface thereof, and constituting said first location, and an auxiliary material chamber of volume V₂ confined between an outer surface of the resilient volumetric member and an inner surface of said rigid control volume; said control volume further comprising at least a target material outlet;
(b) filling said target material chamber with said target material;
(c) introducing a predetermined desired volume ΔV of an incompressible auxiliary material into said auxiliary material chamber to apply pressure to said resilient volumetric member, thereby increasing the volume of the auxiliary material chamber V₂ to V₂′=V₂+ΔV and consequently reducing the volume of the target material chamber from V₁ to V₁′=V₁−ΔV; and
(d) allowing a predetermined amount ΔV of target material to exit the target material chamber through said target material outlet to said second location.

The term auxiliary material chamber may also be referred to hereinafter in the specification and claims as ‘control interstice’.

the term ‘target material’ as used herein the specification and claims denotes any flowable substance such as liquids, slurries, pastes, gels, and any such materials comprising a flowable material with particulate material dispersed therein. An unlimited number of examples may be provided such as Cheese products, dairy products, cosmetics, gravies, dips, sauces, oils, chemical lubricants and other substances.

Said method may be adapted for periodical operation, wherein said method further includes the steps of:
(e) closing said target material outlet;
(f) withdrawing a predetermined volume ΔV of the auxiliary material from said auxiliary material compartment such that the compartments return to their initial volumes V₁ and V₂; and
(g) repeating steps (a) to (d) above.

Hereinafter, the series of steps (a) to (f) will be referred to as a ‘stroke’.

In particular, the rigid control volume may have a nominal dimension D₁ and said resilient volumetric member may have a nominal dimension D₂<D₁, such that for a range of nominal dimensions D₁<12″, the ratio

$$R = \frac{{D}_{1}}{{D}_{2}}$$

between the nominal dimensions of the rigid control volume and the resilient volumetric member may be in the range of 1.5>R>1.1.

Said method may be also adapted for displacing through said target material outlet a different volume of target material on each stroke, thereby allowing

Said method may be used for the filling of receptacles with said target material, and may be employed, for example, in a filling line.

Said method may also be adapted for cleaning the control volume, wherein the method further includes the steps of:
(h) emptying the target material compartment from said target material;
(i) providing a cleaning substance into said target material compartment; and
(j) washing the target material compartment while periodically changing the volumes V₁ and V₂ using said auxiliary material.

It is worth noting that the cleaning operation, during which a cleaning agent is introduced into the target material chamber, is performed under an extensive amount of pressure, which attempts to ‘inflate’ the resilient volumetric member. However, due to the specific ratio R between the dimensions of the control volume and resilient volumetric member, the volumetric member is not allowed to ‘inflate’ to an extent damaging the mechanical integrity thereof, as its inflation is restricted by the rigid walls of the control volume.

The method of the present invention may also be adapted for performing a calibration/reset operation adapted for precisely controlling the initial volumes V₁ and V₂ of the respective target material chamber and auxiliary material camber, which may be applied by the following steps:
(k) providing a withdrawal device being in flow communication with the control interstice and adapted to withdraw material therefrom;
(l) withdrawing material from the control interstice by said withdrawal device until the outer surface of said volumetric resilient member comes in contact with the inner surface of said rigid control volume; and

After completing the calibration steps above, the filling/dosing operation may be performed according to steps (a) to (d).

According to another aspect of the present invention there is provided a system adapted for performing the method according to the previous aspect of the present invention, said system comprising:
a rigid control volume formed with a target material inlet adapted for coupling to a target material supply, an auxiliary material inlet adapted for coupling to a supply line of an incompressible auxiliary material, and a target material outlet;
a resilient volumetric member coaxially contained within said rigid control volume, and having a target material inlet and a target material outlet in fluid communication with the respective target material inlet and outlet of the rigid control volume; and

wherein the rigid control volume is divided into a target material chamber of volume V₁ defined between the target material inlet and outlet of the resilient volumetric member, and an auxiliary material chamber of volume V₂ defined between an outer surface of the resilient volumetric member and an inner surface of rigid control volume, said auxiliary material chamber being in flow communication with said auxiliary material inlet.

Said system may further comprise a target material supply in flow communication with the target material inlet of the control volume, an outlet assembly in flow communication with the target material outlet and adapted for monitoring the discharge of target material through to target material outlet, and an auxiliary material displacement mechanism in flow communication with the auxiliary material inlet and adapted for provision of the incompressible auxiliary material to the control interstice.

In particular, the rigid control volume may have a nominal dimension D₁ and said resilient volumetric member may have a nominal dimension D₂<D₁, such that for a range of nominal dimensions D₁<12″, the ratio

$$R = \frac{{D}_{1}}{{D}_{2}}$$

between the nominal dimensions of the rigid control volume and the resilient volumetric member may be in the range of 1.5>R>1.1.

It should be appreciated that the cross section of the rigid control volume and the resilient volumetric member is not limited to a circular shape, and may be any other polygon, in which case the dimensions D₁, D₂ may refer to the diameter of the inscribing circle of the polygon.

The control volume may further be formed with a control outlet in fluid communication with the control interstice and comprise a pressure control arrangement in fluid communication with said control outlet, adapted for performing calibration/reset of the system, as well as monitoring the mechanical integrity of the resilient volumetric member.

The control pressure arrangement may comprise a pressure line extending from said control interstice, said pressure line being provided with a vacuum generator, a closable outlet and a sensor.

For example, during calibration of the system, the vacuum generator may be adapted to generate vacuum, whereby the resilient volumetric member begins to ‘inflate’, i.e. radially expand, whereby the outer surface thereof comes in contact with the inner surface of the rigid control volume. It is important to note that since the ratio R is chosen as specified above, the resilient volumetric member is prevented from deforming beyond the elastic area thereof.

In addition, the vacuum generator may be adapted for generating vacuum during operation of the system, slightly ‘inflating’ the volumetric resilient member, whereby, in the event of a rupture of puncture in the resilient volumetric member, the sensor is adapted to notify an operator of the system of a possible malfunction and the system may be brought to a halt.

In other words, a liquid branch of the volumetric dosing machine on two parts physically isolated each from other, one liquid part containing the dosed liquid product, and another—the lubricating oil only; as a result, the dosed product has no access to the moving parts of the pump that allows to raise sharply terms of its work and practically having excluded the intensive long time processes of the disassembly, cleaning, replacement of isolating rings, assembly, etc.; the additional increase in the terms of the work and the improvement of the quality of the work of the pump is due to occurrence of the contact of the moving parts of the volumetric dosing machine with the machinery oil;

The new function of the calculation of the optimum control signal moments for the volumetric dosing machine (from the controller of the line) are carried out for each cycle individually on the base of the adaptive mathematical model of the process of the dosing process, including the transfer function of transferring the set volume of the portion throughout the long lubricating oil tube; the adaptation of the mathematical model is carried out under the signals from the weight measuring device giving the information about the received real volume (weight) of the previous portion; the calculation of the new set volume in an air part of the pump is carried out also on the base of using the adaptive mathematical model by means of automated servo-driver of the pump volume adjusting device;

the new volumetric dosing machine is technologically divided into two parts; the part of the dosing machine situated on the stands of the packing line, and the part of the volumetric dosing machine with all auxiliary systems, including the servo-driver situated at a remote location from the packaging line stand, and situated separately in the electro—pneumatic control box of the packaging line; such configuration of the VCD Line allows a substantial reduction of the dimensions and, accordingly, its manufacturing cost;

the technology and the equipment of dividing the dosed liquid product from the lubricating oil, and the control of this dividing, are guarantees against transferring the lubricating oil in to the dosed product, and against transferring the dosed product to the moving parts of the pump, that enables to dose high-viscous liquid products including abrasive materials at excited environments;

the compact technological configuration of the new special module dividing the dosed product from the lubricating oil, in case of the penetration of the dosed product and/or the machinery oil into the dividing module during the dosing process, allows to replace the defected module with a new one during a very short time; better yet, the specified dividing module becomes an additional separate independent product or a spare part for the VCD Line.

### BRIEF DESCRIPTION OF THE DRAWINGS

In order to understand the invention and to see how it may be carried out in practice, embodiments will now be described, by way of non-limiting example only, with reference to the accompanying drawings, in which:

FIGS. 1A to 1H are schematic representations of a system adapted for performing the method of the present invention, shown in different stages of displacement of a target material according to the present invention;

FIGS. 1I to 1M are schematic representations of the system shown in FIGS. 1A to 1H, shown in different stages of a cleaning process according to the present invention;

FIGS. 2A to 2J are schematic representations of stages of calibrating the system shown in FIGS. 1A to 1M;

FIG. 3A is a schematic cross-section of a control volume used in the system shown in FIGS. 1A to 1M;

FIG. 3B is a schematic longitudinal cross-section of the control volume shown in FIG. 3A;

FIG. 4 is a schematic block diagram of the system shown in FIGS. 1A to 1M; and

### DETAILED DESCRIPTION OF EMBODIMENTS

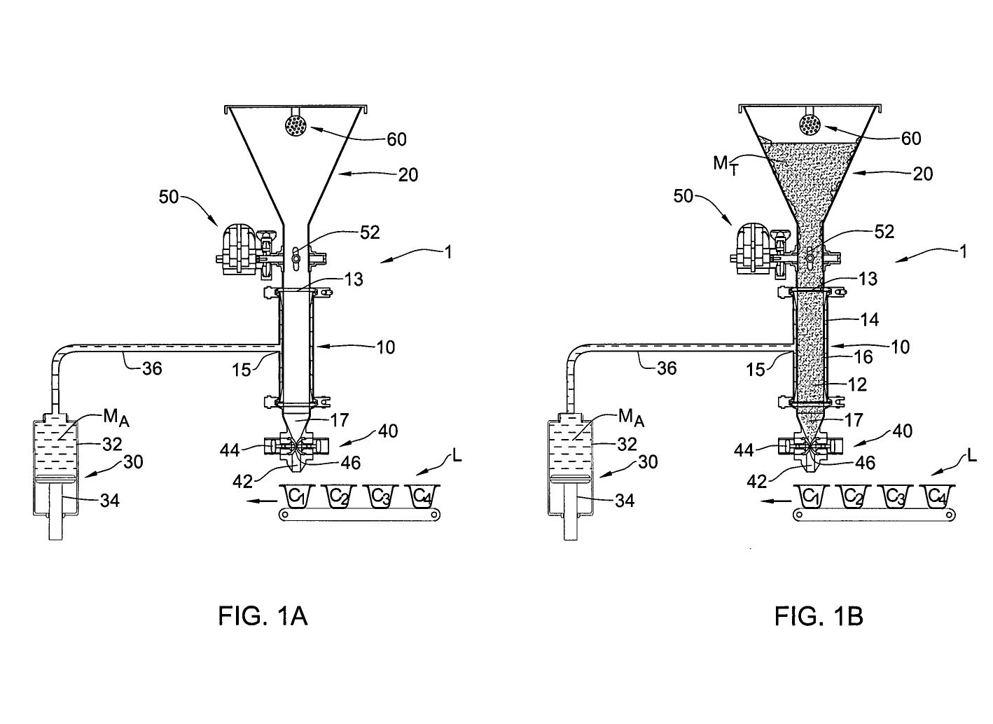

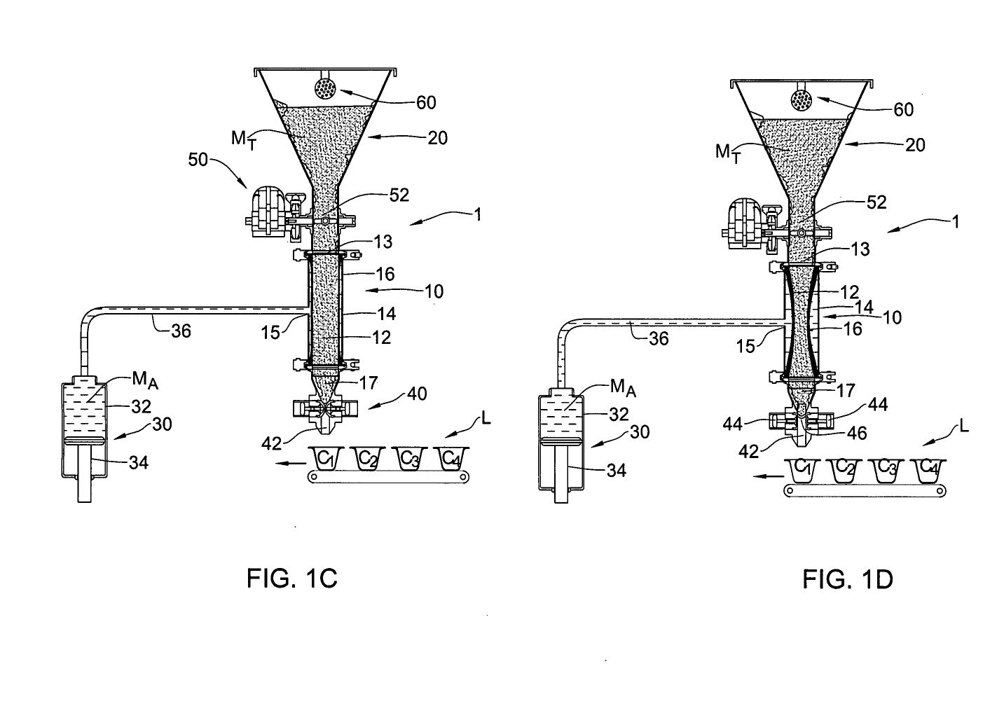

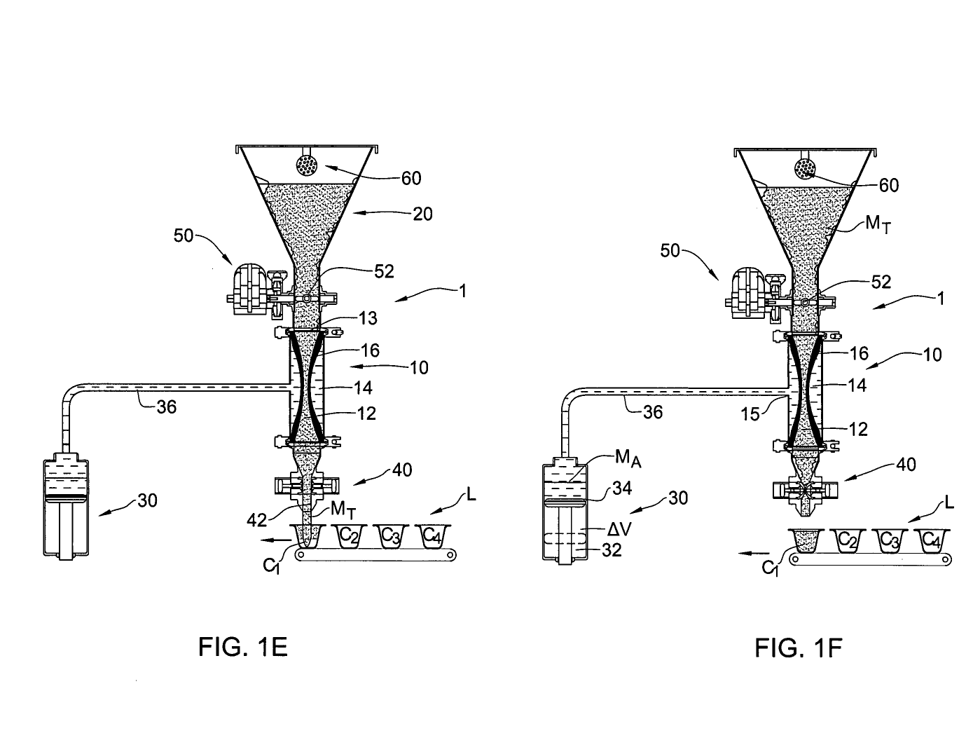

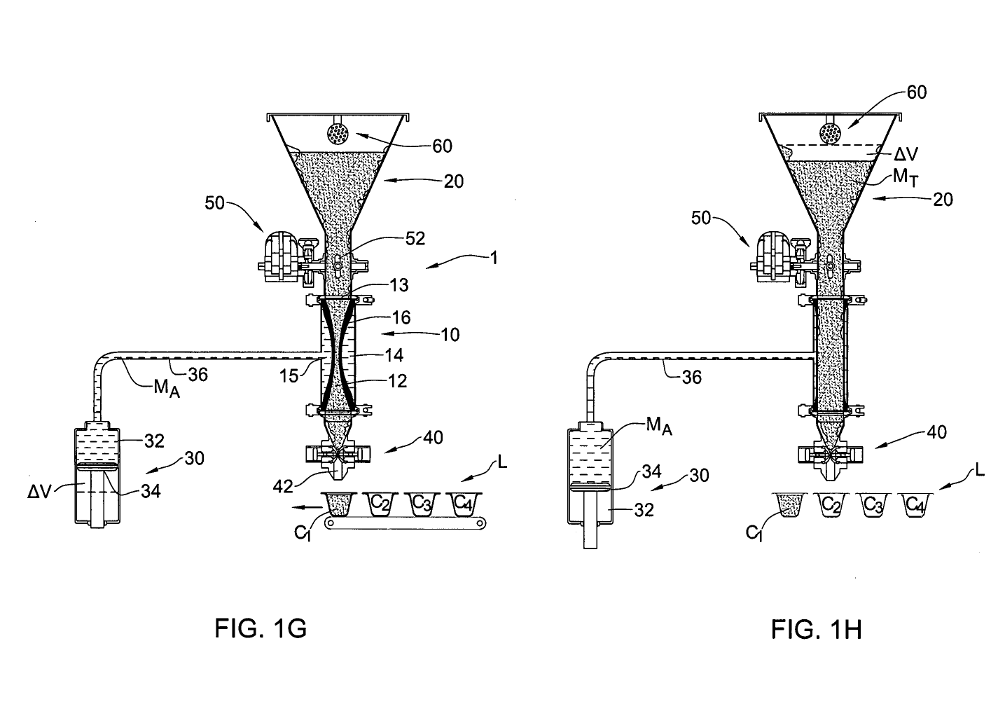

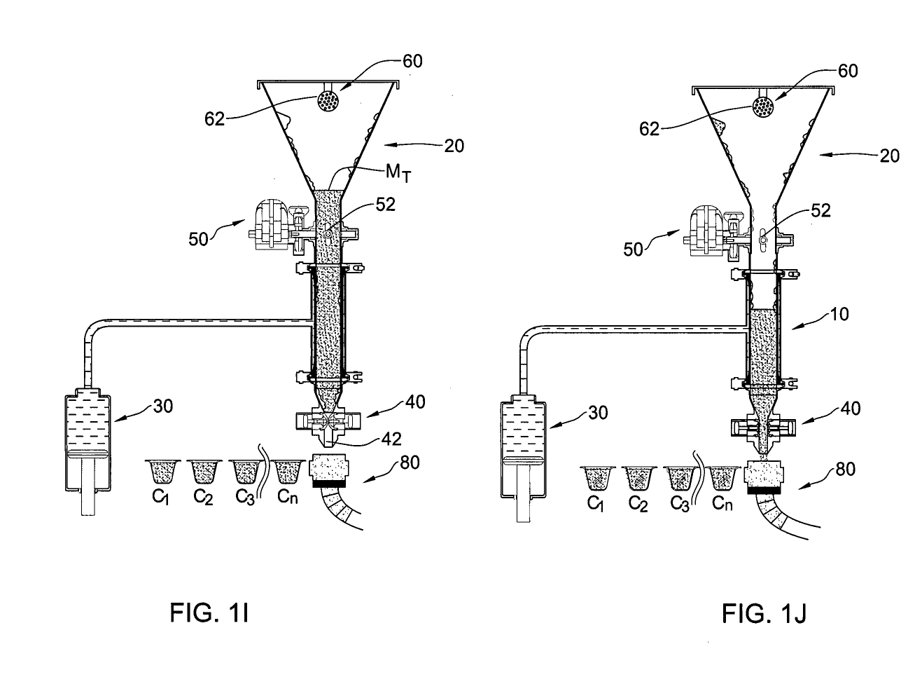

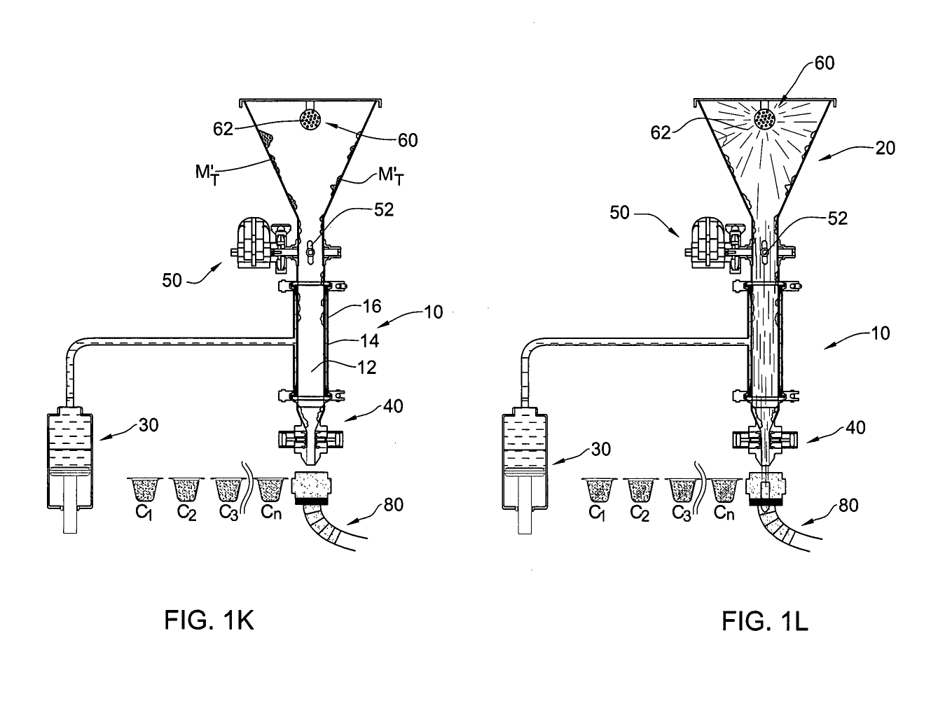

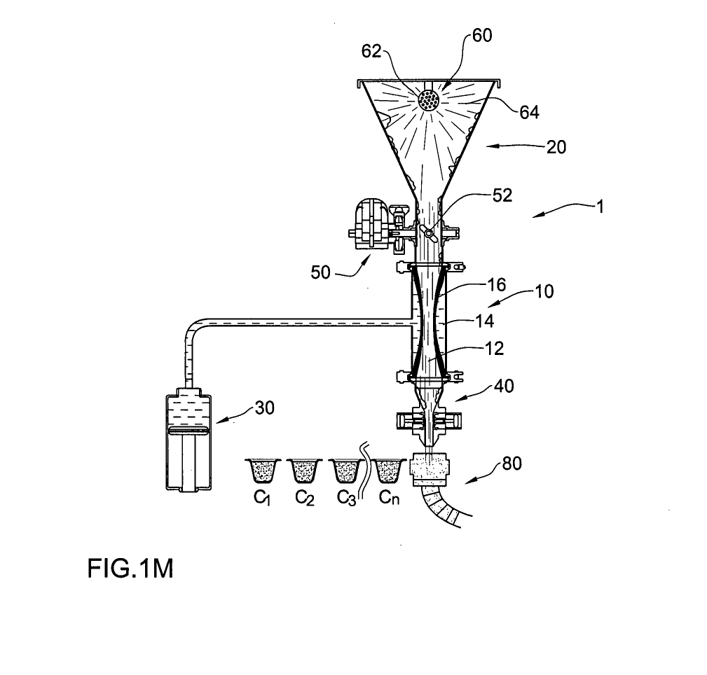

With reference to FIGS. 1A to 1H, a filling system is shown, generally designated as 1 adapted for working in conjunction with a filling line L. The system comprises a control volume portion 10, a target material storage 20, an auxiliary material mechanism 30, an outlet assembly 40, a controller unit 50, and a cleaning arrangement 60.

The control volume portion 10 comprises a target material compartment 12 and an auxiliary material compartment 14, sealingly separated from one another by a resilient diaphragm 16 adapted to deform so as to selectively change the volume of one compartment on the expense of the other compartment. The control volume 10 has a volume V₀ which is constituted at all times by the combined volume V₁ of the target material compartment 12 and volume V₂ of the auxiliary material compartment 14.

The control volume 10 is formed with a first inlet port 13 located at a top end thereof and being in fluid communication with the storage 20 to receive a target material M_{T} therefrom, a second inlet port 15 formed in the auxiliary material compartment 14 and being in fluid communication with the auxiliary material mechanism 30 to receive the auxiliary material M_{A} therefrom, and an outlet port 17 at a bottom end thereof being in fluid communication with the outlet assembly 40.

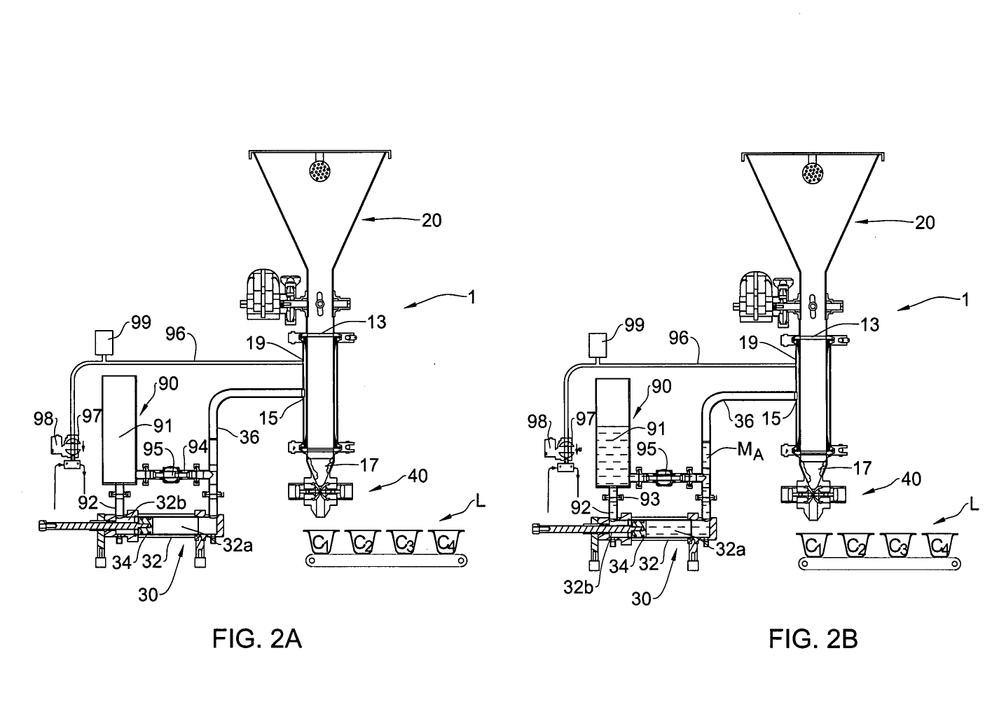

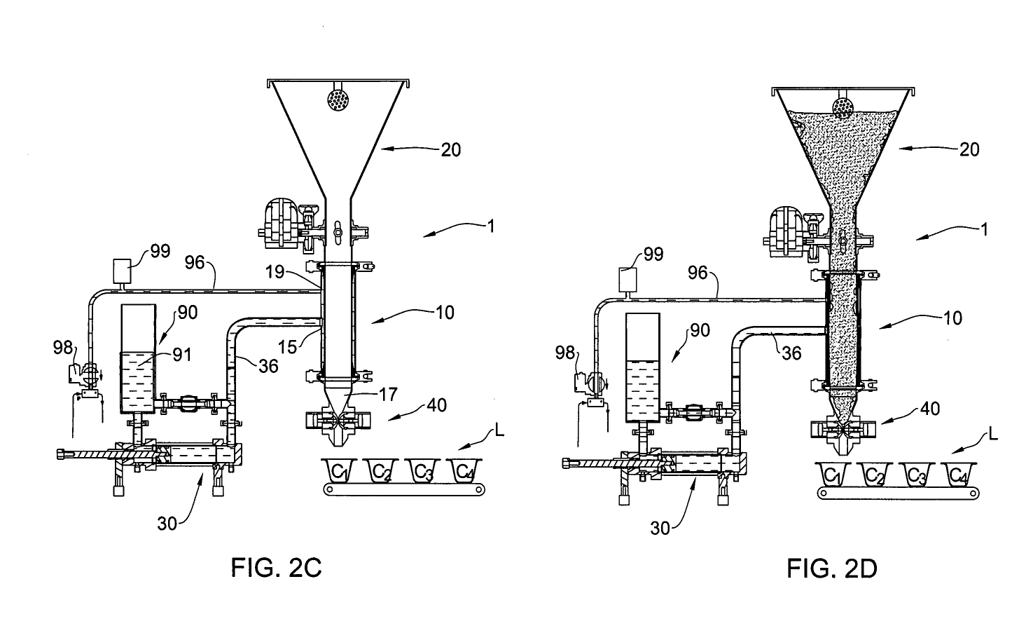

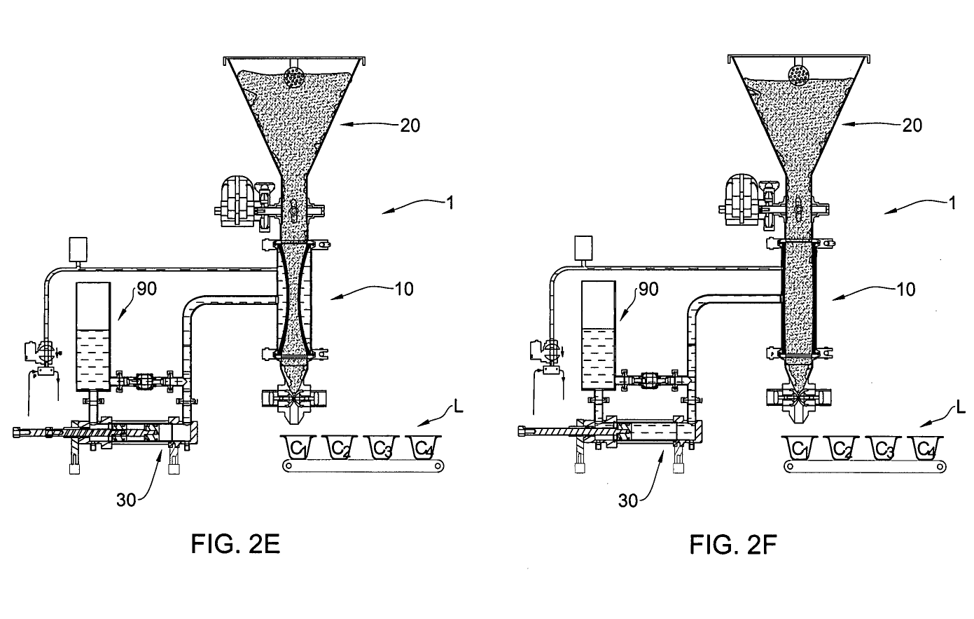

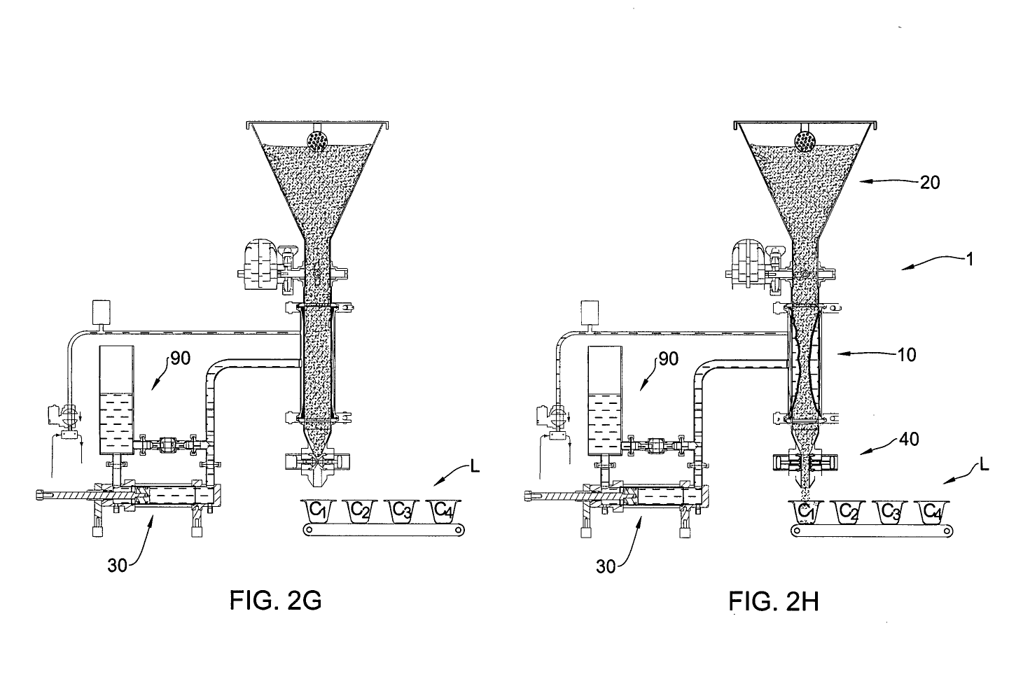

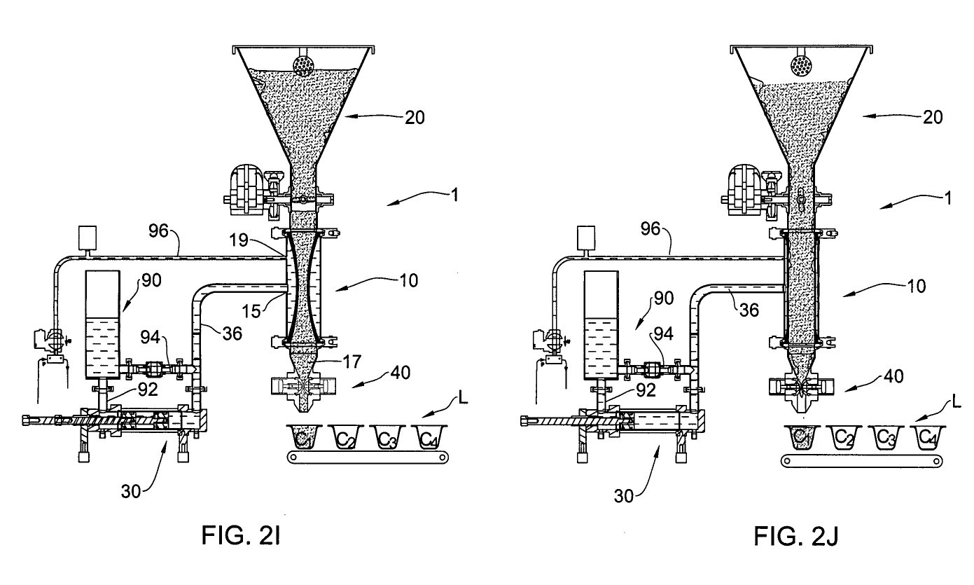

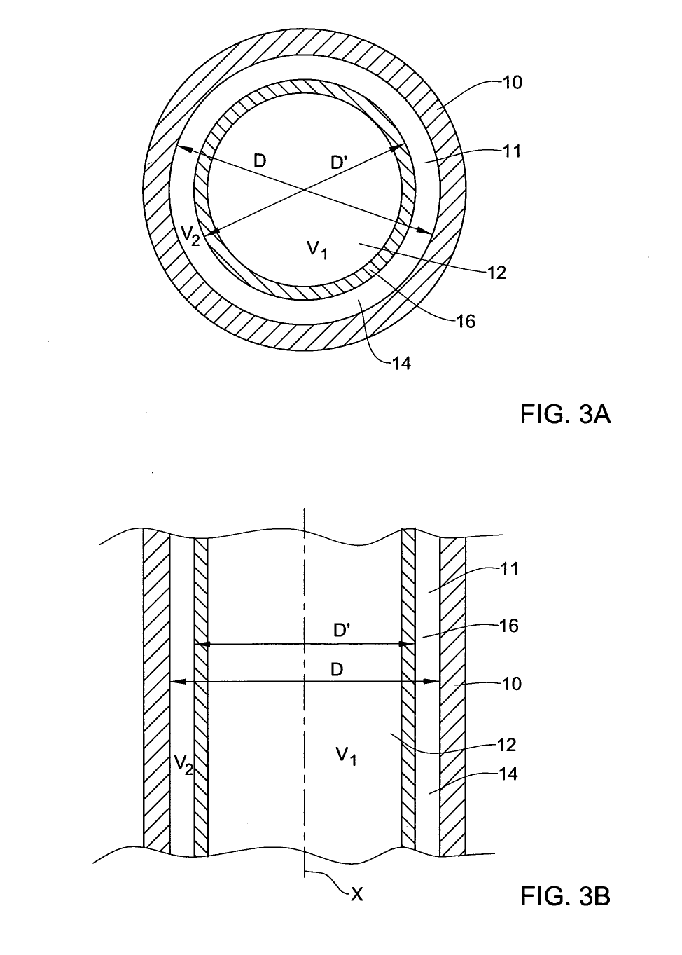

The resilient diaphragm 16 is in the form of a sleeve situated within the rigid control volume 10, the arrangement being such that the resilient diaphragm 16 has a diameter D′ which is slightly smaller than the diameter D of the control volume 10, such that there extends a control interstice 11 between the control volume 10 and the resilient diaphragm 16 (see FIGS. 3A and 3B). The advantages of this gap will be discussed in detail with respect to the filling operation of the system 1, with particular reference to FIGS. 2A to 2J.

The controller unit 50 comprises a stopper 52 located between the first inlet port 13 and the storage 20, adapted to regulate the displacement of material from the storage 20 to the control volume 10. The stopper 52 may assume an open position (shown FIG. 1A) in which target material M_{T} is free to displace from the storage 20 to the control volume 10, and a closed position (shown FIG. 1D) in which the stopper 52 prevents such displacement. It should be appreciated that the stopper 52 may also assume a plurality of intermediary positions between the open position and the closed position.

The auxiliary material mechanism 30 comprises an auxiliary material chamber 32, a piston 34 adapted to linearly displace within the auxiliary material chamber 32, and a fluid communication line 36 adapted to connect the auxiliary material chamber 32 with the second inlet port 15 of the control volume 10.

The outlet assembly 40 comprises a central passage 42, a deformable membrane 44 and two pistons 46 adapted for lateral displacement in order to apply pressure to the deformable membrane 44, whereby the outlet assembly 40 may assume a first, open position in which the target material M_{T} is free to displace along the passage 42 from the control volume 10 to the receptacles C of the filling line, and a second, closed position in which the membrane 44 is deformed to such an extent that the above displacement is prevented.

The filling line L is situated under the outlet assembly 40, and comprises a conveyer belt B having positioned thereon a plurality of containers C₁, C₂ . . . Cₙ adapted to be filled with the target material M_{T}.

At a first stage of the filling operation shown in FIG. 1A, the storage 20 is empty, the stopper 52 is in its open position, and the outlet assembly is also in its closed position.

At a second stage of the filling operation, shown in FIG. 1B, a target material M_{T} is provided into the storage 20, and due to the open position of the stopper 52, the target material M_{T} fills the control volume as well. In this position, the target material compartment 12 of the control volume 10 is fully filled with the target material M_{T}, such that V₁ constitutes the majority of the volume V₀ of the control volume 10 (i.e. V₁≈V₀), and V₂ is approximately zero (i.e. V₂≈0). This position of the control volume 10 may be referred to as a filled position.

At a third stage of the filling operation, shown in FIG. 1C, the stopper 52 is displaced to its closed position such that no additional target material M_{T} may displace from the storage 20 to the control volume 10.

Thereafter, at a fourth stage of the filling operation, shown in FIG. 1D, the outlet assembly 40 is displaced into its open position and the piston 34 of the auxiliary material mechanism 30 begins to displace linearly within the chamber 32 so as to displace a certain volume of the auxiliary material M_{A} into the auxiliary material compartment 14 of the control volume 10. This displacement causes deformation of the resilient diaphragm 16, thereby leading to an increase in the volume V₂ of the auxiliary material compartment 14 on the expense of a decrease in the volume V₁ of the target material compartment 12. This change in volumes, in turn, leads to ejection of the target material M_{T} contained within the control volume 10 through the passage 42 of the outlet assembly 40 and into one of the receptacles C.

Turning now to FIGS. 1E and 1F, at the next step of the filling operation, once a predetermined desired volume ΔV of auxiliary material M_{A} has been displaced by the piston 34, the control volume 10 assumes an emptied position, in which the target material compartment 12 assumes a decreased volume V₁′=V₁−ΔV, and the auxiliary material compartment 14 assumes an increased volume V₂′=V₂+ΔV.

Thus, the volume of the target material M_{T} ejected into the receptacle C₁ is exactly the desired predetermined volume ΔV. At this stage, the pistons 46 of the outlet assembly 40 are displaced towards one another such that the outlet assembly 40 assumes its closed position.

At a following stage of the filling operation, shown in FIGS. 1G and 1H, the stopper 52 is displaced into its open position, and the piston 34 is displaced backwards to withdraw the auxiliary material M_{A} from the auxiliary material compartment 14. This withdrawal entails an increase in the volume of the target material compartment 12 to its original volume V₁, whereby target material M_{T} from the storage 20 is sucked into the control volume 10.

Thus, the control volume 10 returns to a filled position, i.e. the target material compartment 12 is filled with the target material M_{T}, and the volume distribution between the compartment 12, 14 is again V₁≈V₀, and V₂≈0. At this stage, the conveyer belt B of the filling line L progresses to the left so as to position an empty receptacle C₂ under the outlet assembly 40, whereby the stages of the filling operation may be repeated.

The stages described above with reference to FIGS. 1A to 1H define a single stroke of the volume displacement system 1.

It is appreciated that throughout the entire stroke performed by the system 1, there is never any danger of mixture or contamination of the target material M_{T} by the auxiliary material M_{A}.

It is also appreciated that the desired volume ΔV discharged through the outlet assembly 40 into the receptacle C is highly accurate due to the simple control over the piston 34.

In addition, it is noted that even in its most deformed position, the resilient diaphragm 16 leaves a passage path for the target material M_{T}. This path facilitates maintaining the quality of the target material M_{T} contained within the control volume 10, for example, yogurts or clustery slurries do not become crushed or ground. Furthermore, unlike in regular piston systems, in the present invention, there is no compression of the target material M_{T}, wherein when the target material M_{T} is an aerated material, i.e. a material containing a considerable amount of trapped air, the majority of air remains within the target material M_{T}, and does not escape therefrom.

Turning now to FIGS. 1I to 1M, a cleaning operation of the system 1 is shown at different stages of operation thereof.

At a first stage of the cleaning operation, shown in FIGS. 1I and 1J, the stopper 52 and outlet assembly 40 assume their open positions in order to allow draining of the entire target material M_{T} from the control volume 10 and the storage 20. A specially designed suction tube 80 is adapted to attach to the passage 42 of the outlet assembly 40 and drain the target material M_{T}.

At a following stage of the cleaning operation, shown in FIG. 1K, it is observed that although the target material M_{T} is drained, there remains a residual of the target material M_{T} on the side walls 22 of the storage 20, and on the inner side of the resilient diaphragm 16, i.e. within the target material compartment 12.

Thus, at the next stage of the cleaning operation, shown in FIG. 1L, the cleaning arrangement 60 is adapted to emit into the storage 20 and control volume 10 a cleaning agent 64 through a cleaning head 62 thereof. The cleaning agent 64 is sprayed by the cleaning head 62 over the inner walls 22 of the storage and is drained down through to control volume 10 into the suction tube 80.

During this cleaning operation, as shown in FIG. 1M, the auxiliary material mechanism 30 may operate periodically at an increased rate, i.e. the piston 34 being moved pack and forth repeatedly at an increased rate, causing vibration/rapid deformation of the resilient diaphragm 16 so as to facilitate better cleaning of the control volume 10.

Turning now to FIGS. 2A to 2J, the system 1 is shown fitted with an additional pressure regulating mechanism 90 working in conjunction with the auxiliary material mechanism 30, during various stages of preparation and of the filling operation of the system 1.

The pressure regulating mechanism 90 comprises a storage tank 91 being in fluid communication with the piston chamber 32. It is observed that the piston chamber 32 is divided by the piston 34 into a front portion 32a and a rear portion 32a. The tank 91 is connected to the rear portion 32a via a rear line 92 and to the front portion 32a by the front line 94.

The pressure regulating mechanism 90 further comprises a discharge line 96 connecting the auxiliary material compartment 14 with the outside environment through an additional outlet port 19 formed in the control volume 10. The discharge line is fitted with a vacuum generator 98 adapted for withdrawal of the auxiliary material M_{A} through the line 96, and a sensor 99 adapted to monitor the pressure within the line 96.

Each of the lines 92, 94 and 96 are fitted with respective valves 95 and 97, adapted to be selectively opened/closed so as to allow/prevent fluid communication between the tank 91 and the line 36, and between the outlet port 19 and the outside environment.

With particular reference to FIG. 2A, the system 1 is shown during an initial stage of operation, when the storage 20 is empty of target material M_{T}, and the auxiliary material mechanism 30 is empty of auxiliary material M_{A}. It is noted that both portions 32a, 32b are empty, the valve 95 is in its open position and the valve 97 is in its closed position.

At the following stage, shown in FIG. 2B, the storage tank 91 is filled with the auxiliary material M_{A}, and since the valve 95 is in its open position, the auxiliary material M_{A} flows through the lines 92 and 94 to fill both portions 32a and 32b of the chamber 32.

From this stage, as shown in FIGS. 2C and 2D, the valve 97 is opened, and the vacuum generator 98 begins it operation, sucking the auxiliary material M_{A} through line 96 until the chamber 32, line 36, auxiliary material compartment 14 and line 96 are filled with the auxiliary material M_{A}. Thereafter, the valves 95 and 97 are closed, and effectively all the lines 92, 94, 96 and chamber 32 only contain the auxiliary material M_{A} and no excess gas, e.g. air.

In addition, during this stage, calibration of the system may be performed, during which the vacuum generator 98 generates vacuum so as to ‘inflate’ the resilient diaphragm 16, causing the outer surface thereof to come in contact with the inner surface of the control volume 10. In this position, the exact volume of the target material chamber 12 is known to an operator since V₁=V₀, and filling of the storage 20 with the target material M_{T} may be performed, thereby fully preparing the system 1 for performing the filling operation.

At the following stage, shown in FIGS. 2E and 2F, the piston 34 is displaced forwards so as to deform the resilient diaphragm 16, thereby pushing the target material M_{T} within the storage 20 upwards, and the displaces backwards, letting to target material M_{T} drop back into the control volume 10. This operation may be performed several times and is useful for tighter arrangement of the target material M_{T} within the control volume 10, and also makes sure that the entire volume of the target material compartment is filled with the target material M_{T}.

At the following stages shown in FIG. 2G to 2J, the system performs the filling operation, equivalent to that described with respect to FIGS. 2A to 2H.

It is important to note that due to the pressure regulating arrangement 90, the piston 34 is completely immersed in the auxiliary material M_{A}, and the lines 92, 94 and 96 are completely filled with the auxiliary material M_{A}, thereby preventing excess gas such as air to be trapped within the system 1 and effecting volumetric calculations.

It is also appreciated that the pressure regulation mechanism 90 is also adapted to function as a security mechanism in the case that the resilient diaphragm 16 is punctured. In such a case, the vacuum generator 98 is adapted for generating vacuum, thereby preventing any of the auxiliary material M_{A} from penetrating into the target material compartment 12.

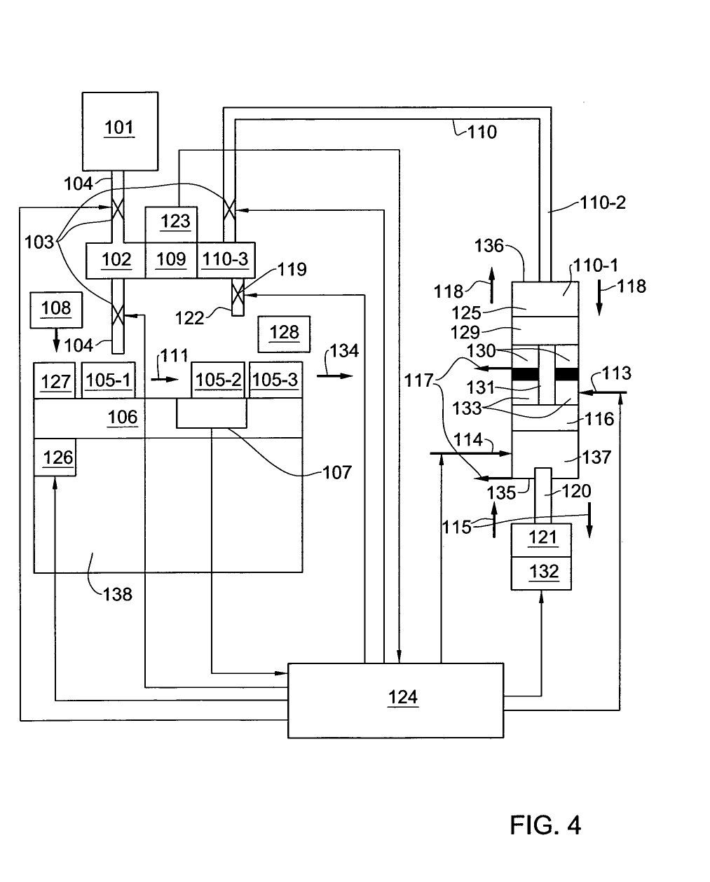

FIG. 4 diagrammatically illustrates one of the possible forms of the block-diagram of the apparatus constructed for realizing the invented method for the volumetric cyclically portioning of liquids and pasted products for the operating speed of 30 portions per minute for one technological sub line for relatively small sizes of the portions, for example, 100-200 ml.

It is to be understood that the foregoing drawing, and the description below, is provided primarily for purposes of facilitating understanding the conceptual aspects of the invented method and various possible embodiments thereof. In the interest of clarity and brevity, no attempt is made to provide more details than necessary to enable one skilled in the art, using routine skill and design, to understand and practice the described invention. It is to be further understood that the embodiments described are for purposes of example only, and that the invented method is capable of being embodied in other forms of block-schemes, diagrams and applications than described herein.

The main parts of the embodiment of the FIG. 4 and its connection are as follows:

108 is a device for supplying empty containers (127) on the conveyor (106) mounted on the packaging line body (138).

126—a driver of the conveyor (106) serving the movement of the containers (105) in the direction (111) and for stopping them on (105-1), for receiving the portion of the dosed product (105-2) and for a control weighing at a weighing device 107 and 105-3 for closing and labeling by device 128.

134 is a direction which the containers are exiting from a line or conveyor 106.

101 is a receiving bunker for a product to be dosed.

136 is a new volumetric dosing machine consisting of a volume forming and control device (125, 129, 130, 131, 133, 116) and a volume copying and dosing device (102, 109, 125, 123).

125 is a liquid chamber consisting of a lubricated oil, connected to stainless steel tubes to transfer the oil (110) equipped by a check valve (103) and an outlet port (122) with a check valve (139).

110-1 is a lubricated oil in the volumetric control device.

110-3 is a lubricated oil in the volume copying device.

110-2 is a lubricated oil in the transferred tube.

110 is a stainless steel tubes which transfer the lubricated oil and provide the long distance control of the dosed portion volume.

129 is a lubricated oil piston.

118 is a direction of a motion for creating a portion volume and for filling a container (105-1), down for creating the portion volume.

130 is a vent chamber with a vent port (117).

133 is an air chamber (the refill stroke).

116 is an air piston mechanically connected (131) with a lubricated oil piston (129).

137 is an air chamber (discharge stroke) with a vent port (117).

135 is a thread seal with automatically adjusted bolt (120) mechanically connected with the servo-drive (121).

121 is a controlled servo driver for regulating the volume of a device 136 with control unit 132.

115 is a “Up/Down” dose adjustments to set product volume (“Down” for receiving more larger portion volume, and “Up” for receiving less portion).

113 is an air pressure for forming a portion volume.

114 is an air pressure for filling the container (105-1).

102 is an dosing liquid chamber of the volume copying device, equipped with inlet (104) and outlet (104) tubes and check valves (103), accordingly.

109 is a chamber structure to divide between an dosing liquid chamber and the volume copying device 110-3. For example: in the form of a “two” membranes device divided by distillated water for instance, and equipped with a control device (123) for an operative control of dividing an dosing product in a dosing liquid chamber (102) from a lubricated oil in a liquid chamber (125).

124 is a computerized control system (for example, a PLC) of a VCD Line receives information from a weighing device (107) and from controlling unit (123), and sends outputting control commands to check valves (103 and 139), the inputs of an air pressure (113 and 114), the conveyor driver (126) and a control unit (132) of a servo-driver (121).

Dynamic Operations of Embodiments

The driver (126) of the conveyor (106) moves the containers (105) in the direction of its motion (111) and stops them at 105-1 (for receiving a portion of the dosed product), 105-2 (for the controlled weighing on the weighing device 107) and 105-3 (for closing and labeling) by the closing and labeling device 128.

During the motion of the conveyor (106), the volumetric dosing machine (136) is preparing a portion (of a dosed product) closed to the targeted volume. The movements within the chambers—102, 109, 125, 130, 133 and 116 are controlled by the reciprocating action of the pump's shaft and the piston assembly. The assembly is operated and controlled by a 4-way air valve which alternately introduces and exhausts the air pressure on both sides of the air piston 116. The 4-way valve would receive its on-off electric signal from the computerized control system 124. This action also causes the lubricated oil piston (129) to reciprocate.

On the down stroke of the lubricated oil piston 129 a vacuum is created in the lubricated oil chamber 125 of the volume forming part of the dosing machine 136 which transferred throughout the lubricated oil tube (110) in to the lubricated oil chamber 125 of the coping part of the dosing machine 136, and a vacuum is created in the dividing and volume coping liquid chamber 109 and in the product dosing liquid chamber 102.

The product dosing liquid chamber 102 is filled automatically by opening upper check valve 103 (at closed lower check valve 103). On the up stroke the product in a chamber 102 is pressurized by the pistons movement and by opening the lower check valve 103 (at closed upper check valve 103), and the dosed product is discharged out the volumetric dosing machine 136.

The developed volumetric dosing machine 136 can be classified as a positive displacement pump with an automatic adjustment by the servo-driver 121 and the control unit 132. All operations of the dosing and automatic adjustments are provided by the computerized control system 124 (for, example, realized on the base of PLC) of the VCD Packaging Line.

1.-20. (canceled)

21. A method for volumetric displacement of a predetermined desired volume ΔV of target material from a first location to a second location, said method comprising the steps of:
(a) providing a rigid control volume having a volume V₀ accommodating a resilient volumetric member coaxially located therein having a target material chamber of volume V₁ confined by an inner surface thereof, and constituting said first location, and an auxiliary material chamber of volume V₂ confined between an outer surface of the resilient volumetric member and an inner surface of said rigid control volume; said control volume further comprising at least a target material outlet;
(b) filling said target material chamber with said target material;
(c) introducing a predetermined desired volume ΔV of an incompressible auxiliary material into said auxiliary material chamber to apply pressure to said resilient volumetric member, thereby increasing the volume of the auxiliary material chamber V₂ to V₂′=V₂+ΔV and consequently reducing the volume of the target material chamber from V₁ to V₁′=V₁−ΔV; and
(d) allowing a predetermined amount ΔV of target material to exit the target material chamber through said target material outlet to said second location;
(e) calibrating comprising providing a withdrawal device coupled to the control interstice and configured to withdraw material therefrom; and
(f) withdrawing material from the control interstice by said withdrawal device until the outer surface of said volumetric resilient member comes in contact with the inner surface of said rigid control volume.

22. The method according to claim 21, wherein said method is configured for continuously and periodically performing a stroke constituted by stages (a) to (d).

23. The method according to claim 21, wherein said method further comprises the steps of:
(g) closing said target material outlet; and
(h) withdrawing a predetermined volume ΔV of the auxiliary material from said auxiliary material compartment such that the compartments return to their initial volumes V₁ and V₂.

24. The method according to claim 22, wherein said method is configured for displacing through said target material outlet a different volume of target material on each stroke.

25. The method according to claim 23, wherein said method is configured for performing a cleaning operation comprising the steps of:
(i) emptying the target material compartment from said target material;
(j) providing a cleaning substance into said target material compartment; and
(k) washing the target material compartment while periodically changing the volumes V₁ and V₂ using said auxiliary material.

26. The method according to claim 21, wherein said rigid control volume is of a nominal dimension D₁ and said resilient volumetric member is of a nominal dimension D₂<, such that for a range of nominal dimensions D₁<12″, the ratio
$$R = \frac{{D}_{1}}{{D}_{2}}$$
between the nominal dimensions of the rigid control volume and the resilient volumetric member is in the range of 1.5>R>1.1.

27. The method according to claim 21, wherein said auxiliary material chamber is in the form of a control interstice.

28. The method according to claim 21, wherein said method is used for the filling of receptacles with said target material, and is employed in a filling line.

29. The system configured for performing the method of claim 21, said system comprising:
a rigid control volume formed with a target material inlet configured for coupling to a target material supply, an auxiliary material inlet configured for coupling to a supply line of an incompressible auxiliary material, and a target material outlet; and
a resilient volumetric member coaxially contained within said rigid control volume, and having a target material inlet and a target material outlet in fluid communication with the respective target material inlet and outlet of the rigid control volume,
wherein the rigid control volume is divided into a target material chamber of volume V₁ defined between the target material inlet and outlet of the resilient volumetric member, and an auxiliary material chamber of volume V₂ defined between an outer surface of the resilient volumetric member and an inner surface of rigid control volume, said auxiliary material chamber being in flow communication with said auxiliary material inlet; and wherein said control volume is further formed with a control outlet in fluid communication with the auxiliary material chamber and comprises a pressure control arrangement in fluid communication with said control outlet configured for performing calibration/reset of the system.

30. The system according to claim 29, wherein said system further comprises:
a target material supply in fluid communication with the target material inlet of the control volume;
an outlet assembly in fluid communication with the target material outlet and adapted for monitoring the discharge of target material through to target material outlet; and
an auxiliary material mechanism in fluid communication with the auxiliary material inlet and adapted for periodic provision of the incompressible auxiliary material to the auxiliary material chamber.

31. The system according to claim 30, wherein said rigid control volume has a nominal dimension D₁ and said resilient volumetric member has a nominal dimension D₂<D₁, such that for a range of nominal dimensions D₁<12″, the ratio
$$R = \frac{{D}_{1}}{{D}_{2}}$$
between the nominal dimensions of the rigid control volume and the resilient volumetric member is in the range of 1.5>R>1.1.

32. The system according to claim 31, wherein said auxiliary material chamber is in the form of a control interstice.

33. The system according to claim 29, wherein said pressure control arrangement comprises a pressure line extending from said control interstice, said pressure line being provided with a vacuum generator, a closable outlet and a sensor.

34. The system according to claim 29, wherein said pressure control arrangement is configured for monitoring the mechanical integrity of the resilient volumetric member.

35. The system according to claim 29, wherein said ratio R is such that during a calibration operation, said resilient volumetric member is prevented from plastic deformation.

36. The system according to claim 33, wherein the sensor is configured to detect puncture of rupture in the resilient volumetric member.
